(19) United States
(12) Patent Application Publication
(10) Pub. No.: US 2022/0342770 A1
(43) Pub. Date: Oct. 27, 2022

(54) METHOD AND SYSTEM FOR GENERATING VIRTUAL SYNTHETIC FULL BACKUPS OF VIRTUAL MACHINES

(71) Applicant: EMC IP Holding Company LLC, Hopkinton, MA (US)

(72) Inventors: Manjunath Jagannatha, Bangalore (IN); Kiran Kumar Madiraju Varadaraju, Bangalore (IN); Ravi Kishore Yadav Rangapuram, Bangalore (IN)

(21) Appl. No.: 17/236,407

(22) Filed: Apr. 21, 2021

(51) Int. Cl. G06F 11/14; G06F 9/455

(52) U.S. Cl. CPC G06F 11/1464; G06F 9/45533; G06F 11/1469; G06F 2201/80; G06F 2201/84

(57) ABSTRACT

Techniques described herein relate to a method for backing up virtual machines. The method may include obtaining, by a backup storage, a virtual synthetic full backup request targeting virtual machine data of a virtual machine; and in response to the virtual synthetic full backup request: identifying, in the backup storage, backup extents using backup metadata; generating an intermediate backup that includes the backup extents, where each of the backup extents is a reference to one of any number of virtual machine data blocks in a full backup; obtaining modified virtual machine data blocks from a production host, where the modified virtual machine data blocks are obtained from a virtual machine snapshot of the virtual machine data; and generating a virtual synthetic full backup using the intermediate backup and the modified virtual machine data blocks.

### BACKGROUND

Computing devices may include any number of internal components such as processors, memory, and persistent storage. Each of the internal components of a computing device may be used to generate data. The process of generating, storing, and backing-up data may utilize computing resources of the computing devices such as processing and storage. The utilization of the aforementioned computing resources to generate backups may impact the overall performance of the computing resources.

### SUMMARY

In general, certain embodiments described herein relate to a method for backing up virtual machines. The method may include obtaining, by a backup storage, a virtual synthetic full backup request targeting virtual machine data of a virtual machine; and in response to the virtual synthetic full backup request: identifying, in the backup storage, backup extents using backup metadata; generating an intermediate backup that includes the backup extents, where each of the backup extents is a reference to one of any number of virtual machine data blocks in a full backup; obtaining modified virtual machine data blocks from a production host, where the modified virtual machine data blocks are obtained from a virtual machine snapshot of the virtual machine data; and generating a virtual synthetic full backup using the intermediate backup and the modified virtual machine data blocks.

In general, certain embodiments described herein relate to a system for backing up virtual machines. The system may include persistent storage for storing backup metadata and a file system manager of a backup storage. The file system manager may be programmed to obtain a virtual synthetic full backup request targeting virtual machine data of a virtual machine; and in response to the virtual synthetic full backup request: identify backup extents using the backup metadata; generate an intermediate backup that includes the backup extents, where each of the backup extents is a reference to one of any number of virtual machine data blocks in a full backup; obtain modified virtual machine data blocks from a production host, where the modified virtual machine data blocks are obtained from a virtual machine snapshot of the virtual machine data; and generate a virtual synthetic full backup using the intermediate backup and the modified virtual machine data blocks.

In general, certain embodiments described herein relate to a non-transitory computer readable medium that includes computer readable program code, which when executed by a computer processor enables the computer processor to perform a method for backing up virtual machines. The method may include obtaining, by a backup storage, a virtual synthetic full backup request targeting virtual machine data of a virtual machine; and in response to the virtual synthetic full backup request: identifying, in the backup storage, backup extents using backup metadata; generating an intermediate backup that includes the backup extents, where each of the backup extents is a reference to one of any number of virtual machine data blocks in a full backup; obtaining modified virtual machine data blocks from a production host, where the modified virtual machine data blocks are obtained from a virtual machine snapshot of the virtual machine data; and generating a virtual synthetic full backup using the intermediate backup and the modified virtual machine data blocks.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a persistent storage of a backup storage in accordance with one or more embodiments of the invention.

FIG. 2A shows a diagram of backup metadata in accordance with one or more embodiments of the invention.

FIG. 2B shows a diagram of a backup in accordance with one or more embodiments of the invention.

FIG. 3A shows a flowchart of a method for generating a full backup in accordance with one or more embodiments of the invention.

FIG. 3B shows a flowchart of a method for generating a virtual synthetic full backup using an intermediate backup in accordance with one or more embodiments of the invention.

FIG. 4A shows a diagram of a first example in accordance with one or more embodiments of the invention.

FIGS. 4B-4C show diagrams of a second example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to a method and system for backing up virtual machines. More specifically, embodiments of the invention relate to generating virtual synthetic full backups that include virtual machine data blocks using intermediate backups. Further, in various embodiments of the invention, an intermediate backup is generated using the backup extents of a previous backup and is merged with modified virtual machine data blocks to generate a virtual synthetic full backup. This enables the generation of virtual synthetic full backups of virtual machines without redundantly reading, writing, and/or transmitting unmodified virtual machine data blocks, thereby increasing the computational efficiency of generating backups of virtual machines.

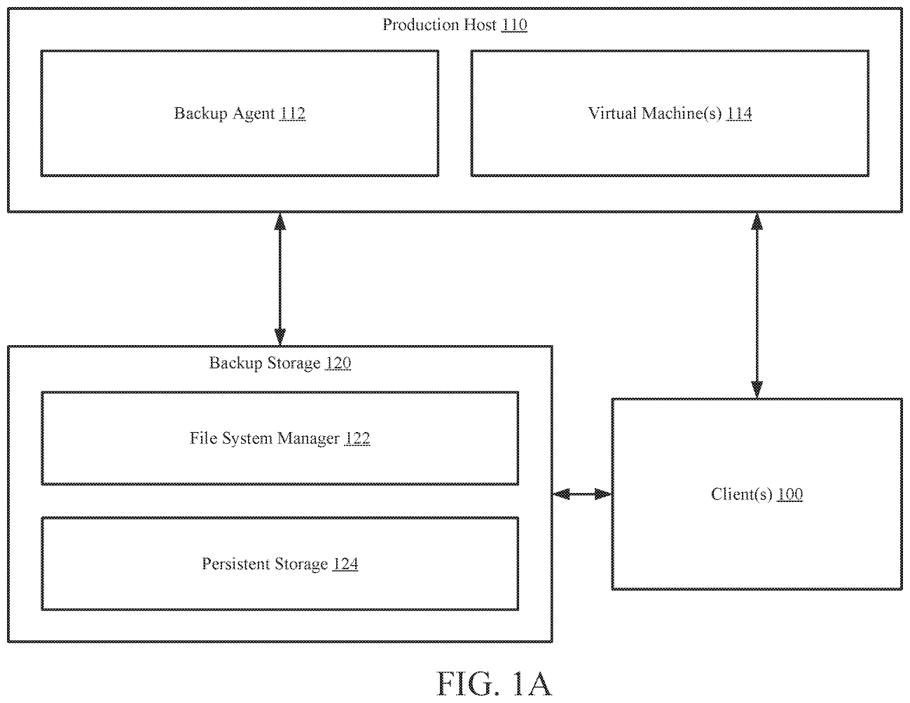

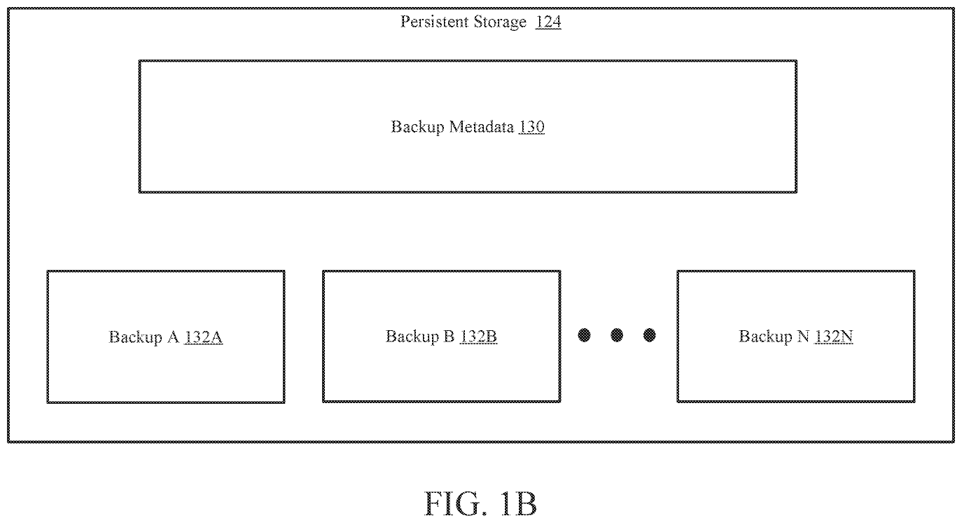

FIG. 1A shows a diagram of a system in accordance with one or more embodiments of the invention. The system may include client(s) (100), a production host (110), and backup storage (120). The system may include additional, fewer, and/or different components without departing from the invention. Each component may be operably connected to any of the other components via any combination of wired and/or wireless connections. Each of the aforementioned components is discussed below.

In one or more embodiments of the invention, the production host (110) provides computer implemented services to the client(s) (100). The production host (110) may include a backup agent (112) and virtual machine(s) (114). The production host (110) may include additional, fewer, and/or different components without departing from the invention. Each of the aforementioned components of the production host (110) is discussed below.

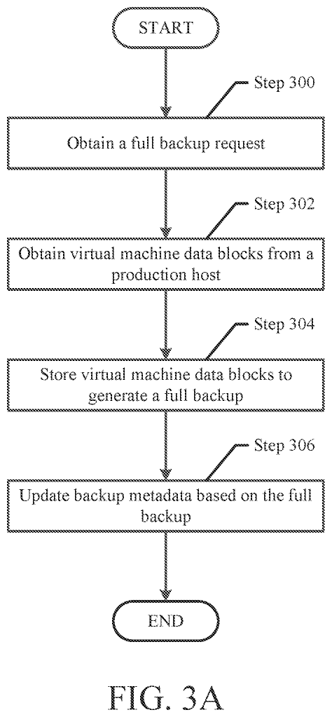

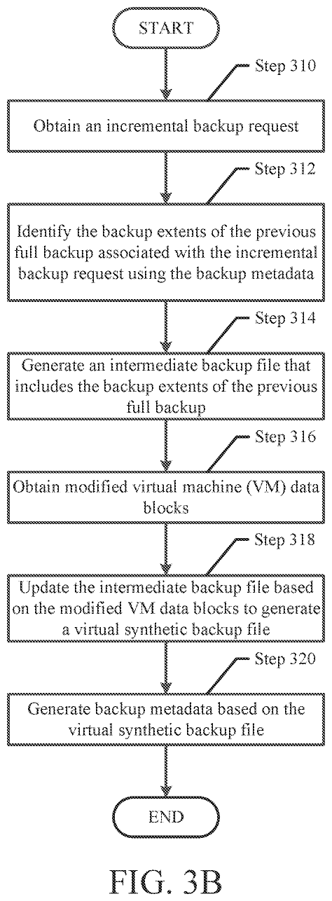

In one or more embodiments of the invention, the production host (110) includes a backup agent (112). The backup agent (112) may include functionality to generate and/or obtain snapshots of the virtual machine(s) (114). The snapshots may include virtual machine data blocks of virtual machine assets included in a file system. The backup agent (112) may further include the functionality to provide the snapshots to the virtual machine(s) (114) to the backup storage (120). In one or more embodiments of the invention, a file system is an organizational data structure that tracks how virtual machine data is stored and retrieved in a system (e.g., in persistent storage of the production host (110), not shown). The file system may specify references to assets of virtual machines and any virtual machine data blocks associated with each asset. An asset may be an individual data object in the file system. An asset may be, for example, a file associated with the virtual machine(s) (114). The snapshot may include a copy of the assets for one or more specified virtual machines associated with a specified point in time. The copies of virtual machine data blocks included in the snapshot may be used to generate full backups, intermediate backups, and virtual synthetic full backups via the methods illustrated in FIGS. 3A-3B.

In one or more embodiments of the invention, the backup agent (112) may further include functionality for tracking changes to assets of the file system and to provide the modified virtual machine data blocks associated with the changed assets to the backup storage (120). The virtual machine data blocks may be stored contiguously or non-contiguously in the persistent storage (not shown) on the production host (110) and the backup storage (120). In other words, virtual machine data blocks may and/or may not be stored in portions of a persistent storage system that are physically located near each other (e.g., next to each other). The backup agent (112) may include other and/or additional functionality without departing from the invention.

In one or more embodiments of the invention, the backup agent (112) may generate and provide to the backup storage (120) the copies of virtual machine data blocks of assets of the file system based on backup policies implemented by the backup agent (112). The backup policies may specify a schedule in which the virtual machines (e.g., 114) are to be backed up. The backup agent (112) may be triggered to generate a snapshot of virtual machines (e.g., 114) and provide the virtual machine data block copies to the backup storage (120) in response to a backup policy. Alternatively, one or more of the copies of data blocks of assets of virtual machines may be generated by a snapshot of the virtual machines and provided to the backup storage (120) in response to a backup request triggered by the client(s) (100). The backup request may specify the virtual machine(s) (114) to be backed up.

In one or more embodiments of the invention, the backup agent (112) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup agent (112) described throughout this application.

In one or more embodiments of the invention, the backup agent (112) is implemented as computer instructions, e.g., computer code, stored on a persistent storage that when executed by a processor of the production host (110) causes the production host (110) to provide the functionality of the backup agent (112) described throughout this application.

In one or more embodiments of the invention, the production host (110) hosts one or more virtual machines (114). The virtual machines (114) may be logical entities executed using computing resources (not shown) of the production host (110) (not shown). Each of the virtual machines (114) may be performing similar or different processes. In one or more embodiments of the invention, the virtual machines (114) provide services to users, e.g., clients (100). For example, the virtual machines (114) may host components. The components may be, for example, instances of databases, email servers, and/or other applications. The virtual machines (114) may host other types of components without departing from the invention.

In one or more of embodiments of the invention, the virtual machine(s) (114) is implemented as computer instructions, e.g., computer code, stored on a persistent storage that when executed by a processor(s) of the production host (110), cause the production host (110) to provide the functionality of the virtual machine(s) (114) described throughout this application.

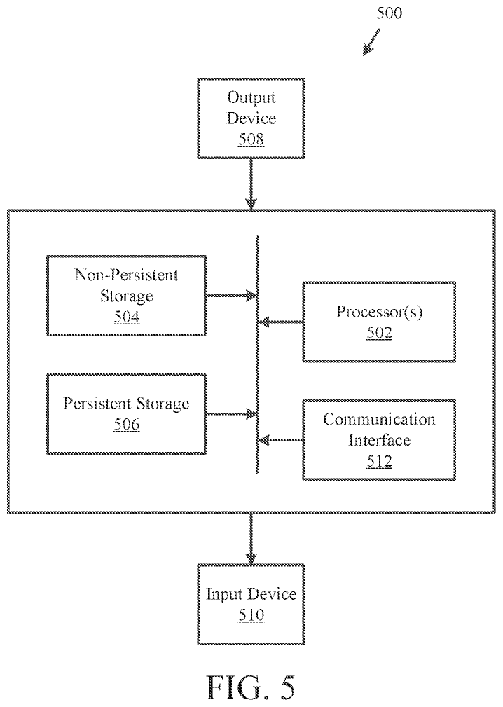

In one or more embodiments of the invention, the production host (110) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host (110) described throughout this application.

In one or more embodiments of the invention, the production host (110) is implemented as a logical device. The logical device may utilize the computing resources of any number of computing devices and thereby provide the functionality of the production host (110) described throughout this application.

In one or more embodiments of the invention, the client(s) (100) utilize services provided by the production host (110). Specifically, the client(s) (100) may utilize the virtual machines (e.g., 114) to obtain, modify, and/or store data. The data may be generated from virtual machines (e.g., 114) hosted in the production host (110).

In one or more embodiments of the invention, a client(s) (100) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client(s) (100) described throughout this application.

In one or more embodiments of the invention, the client(s) (100) are implemented as a logical device. The logical device may utilize the computing resources of any number of computing devices and thereby provide the functionality of the client(s) (100) described throughout this application.

In one or more embodiments of the invention, the backup storage (120) includes the functionality to generate and store backups of assets of the file system using copies of virtual machine data blocks obtained from the backup agent (112) of the production host (110). The backup storage (120) may include an advanced file system that enables the file system manager (122) to generate virtual synthetic full backups as discussed in FIGS. 3A-3B. The advanced file systems may include, for example, Resilient File System (ReFS), Btrfs, XFS, and any other advanced file system that enables the file system manager (122) to perform the methods discussed in FIGS. 3A-3B without departing from the invention. The backup storage (120) may include a file system manager (122) and persistent storage (124). The backup storage (120) may include other and/or additional components without departing from the invention. Each of the components of the backup storage (120) is discussed below.

In one or more embodiments of the invention, the backup storage (120) includes a file system manager (122). The file system manager (122) may include functionality for generating full backups, intermediate backups, and virtual synthetic full backups using copies of virtual machine data blocks of assets of a file system obtained from the backup agent (112) of the production host (110). The file system manager may include the functionality to store the generated backups in persistent storage of the backup storage (120) and to generate backup metadata associated with the generated backups. The file system manager (122) may generate full backups, intermediate backups, and virtual synthetic full backups via the methods illustrated in FIGS. 3A-3B. The file system manager (122) may include other and/or additional functionality without departing from the invention.

In one or more embodiments of the invention, the file system manager (122) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the file system manager (122) described throughout this application.

In one or more embodiments of the invention, the file system manager (122) is implemented as computer instructions, e.g., computer code, stored on a persistent storage that when executed by a processor of the backup storage (120) causes the backup storage (120) to provide the functionality of the file system manager (122) described throughout this application.

In one or more embodiments of the invention, the persistent storage (124) stores data. The data stored in persistent storage (124) may include backups of virtual machine data blocks associated with assets of a file system on the production host (110). The persistent storage (124) may store other and/or additional data without departing from the invention. For additional information regarding the persistent storage, refer to e.g., FIG. 1B.

The persistent storage (124) may be implemented using physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the persistent storage (124) may utilize portions of any combination of hard disk drives, solid state disk drives, tape drives, and/or any other physical storage medium of any number of computing devices.

In one or more embodiments of the invention, the backup storage (120) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device cause the computing device to perform the functionality of the backup storage (120) described throughout this application.

In one or more embodiments of the invention, the backup storage (120) is implemented as a logical device. The logical device may utilize the computing resources of any number of computing devices and thereby provide the functionality of the backup storage (120) described throughout this application.

FIG. 1B shows a diagram of a persistent storage of a backup storage in accordance with one or more embodiments of the invention. The persistent storage (124) may be an embodiment of the persistent storage discussed above in FIG. 1A. As discussed above, the persistent storage stores data. The data may include one or more data structures. The data structures may include backup metadata (130), and one or more backups (e.g., backup A (132A), backup B (132B), and backup N (132N)). The persistent storage (124) may store other and/or additional data structures without departing from the invention. Each of the data structures is discussed below.

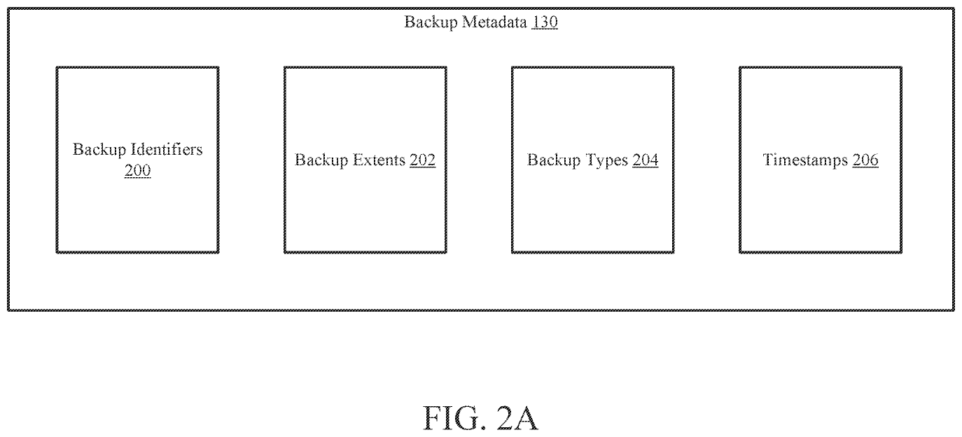

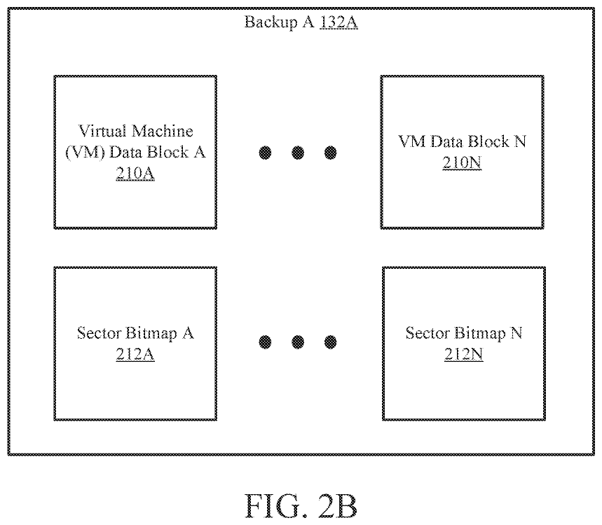

In one or more embodiments of the invention, the backup metadata (130) is one or more data structures that includes information regarding the backups (e.g., 132A, 132B, 132N) stored in the backup storage (120). For additional information regarding the backup metadata, refer to e.g., FIG. 2A.

In one or more embodiments of the invention, the backups (132A, 132B, 132N) are one or more data structures that include copies of virtual machine data of assets of a file system hosted by the production host (110, FIG. 1A). For additional information regarding the backups (132A, 132B, 132N), refer to e.g., FIG. 2B.

FIG. 2A shows a diagram of backup metadata in accordance with one or more embodiments of the invention. The backup metadata (130) may be an embodiment of the backup metadata (130, FIG. 1B) discussed above. As discussed above, the backup metadata (130) may include information regarding backups (e.g., 132A, 132B, 132N, FIG. 1B) stored in the backup storage (120, FIG. 1A). The backup metadata (130) may include one or more data structures. The data structures may include backup identifiers (200), backup extents (202), backup types (204), and timestamps (206). The backup metadata (130) may include other and/or additional data structures and/or information without departing from the invention.

In one or more embodiments of the invention, the backup identifiers (200) are one or more data structures that are used to differentiate between backups stored in the backup storage (120, FIG. 1A). The backup identifiers (200) may be generated and assigned by the backup storage (120, FIG. 1A) or the file system manager (122, FIG. 1A) when a backup is generated and stored in persistent storage (124, FIG. 1A). The backup identifiers (200) may be a unique combination of bits that are each associated with a backup stored in persistent storage (124, FIG. 1A). The file system manager (122, FIG. 1A) may use the backup identifiers (200) to perform all or a portion of the methods illustrated in FIGS. 3A-3B. The backup identifiers (200) may also include object identifiers, or a unique combination of bits included in the unique combination of bits of the backup identifier generated by the production host (110) that is associated with an object. The object identifiers may be used to identify backups associated with an object. The backup identifiers (200) may include other and/or additional information and may be used for other and/or additional purposes without departing from the invention.

In one or more embodiments of the invention, the backup extents (202) are one or more data structures that specify where a virtual machine data block and/or portions of virtual machine data blocks of a backup begin and end in the persistent storage (124, FIG. 1A) of the backup storage (120, FIG. 1A). The backup extents (202) may be generated by the file system manager (122, FIG. 1A) when a backup is stored in the persistent storage (124, FIG. 1A) of the backup storage (120, FIG. 1A). The backup extents (202) may be pointers that reference locations in persistent storage (124, FIG. 1A) where a virtual machine data block of a backup begins and ends. The backup extents (202) may include logical cluster numbers and virtual cluster numbers, which specify where virtual machine data blocks are stored in persistent storage. Each virtual machine data block may be assigned a virtual cluster number and each portion (i.e., cluster of a volume) of the persistent storage (124, FIG. 1A) may include a logical cluster number. Virtual machine data blocks may be located in the persistent storage (124, FIG. 1A) based on the mappings of virtual cluster numbers to logical cluster numbers associated with the virtual machine data blocks. The backup extents (202) may be used to identify where in persistent storage (124, FIG. 1A) data of virtual machine data blocks are stored. Each backup extent of the backup extents (202) may be associated with a virtual machine data block of a backup. The backup extents (202) may be used by the file system manager (122, FIG. 1A) to generate intermediate backups and virtual synthetic full backups via all or a portion of the methods illustrated in FIGS. 3A-3B. The backup extents (202) may include other and/or additional information and may be used for other and/or additional purposes without departing from the invention.

In one or more embodiments of the invention, the backup types (204) are one or more data structures that specify the types of backups stored in the backup storage (120). The backup types (204) may specify the type of backup of the backups associated with the backup types. The backup types (204) may include full backups, intermediate backups, and virtual synthetic full backups. The backups types may be used by the file system manager (122, FIG. 1A) to identify backups of a specific type via all or a portion of the methods depicted in FIGS. 3A-3B. The backup types (204) may include other and/or additional information and may be used for other and/or additional purposes without departing from the invention. Each of the backup types is discussed below.

A full backup may be a backup that includes all of the virtual machine data of the virtual machine data blocks of an object. An intermediate backup may be a backup that includes the backup extents (202) of a previous full or virtual synthetic full backup. The intermediate backups may not include virtual machine data of virtual machine data blocks. Intermediate backups may be updated using modified virtual machine data blocks to generate virtual synthetic full backups. The virtual synthetic full backups may be backups that include backup extents of a previous full backup or virtual synthetic full backup included in an intermediate backup and virtual machine data of virtual machine data blocks that were modified since the generation of the previous full backup or virtual synthetic full backup associated with the intermediate backup. The aforementioned backup types may include other and/or additional information without departing from the invention.

The backup types (204) may be denoted in the backup metadata (130) via flags. The backup flags may include full backup flags, intermediate backup flags, and virtual synthetic flags. The backup metadata (130) associated with a backup may include flags for each backup type of the backup types (204). The backup type associated with the flag that is set may correspond to the type of backup that is associated with a backup. For example, the backup types (204) included in the backup metadata (130) for a backup may include a full backup flag that is set, an intermediate flag that is not set, and a virtual synthetic flag that is not set. Based on the flags, the backup type of the backup in this scenario is a full backup. Backup types (204) may be denoted via other and/or additional information included in the backup metadata without departing from the invention.

In one or more embodiments of the invention, the timestamps (206) are one or more data structures that specify the time when backups are stored in the backup storage (120). The timestamps may be generated by the file system manager (122, FIG. 1A) when a backup is generated and stored in the persistent storage (124, FIG. 1A) of the backup storage (120, FIG. 1A). The timestamps (206) may be used by the file system manager (122, FIG. 1A) to identify the most recent previously generated backups when generating a virtual synthetic full backup. Each backup stored in the backup storage (120, FIG. 1A) may be associated with a timestamp. The timestamps (206) may include a date and a time that represent when a backup was generated. The timestamps (206) may include other and/or additional information regarding when a backup was generated without departing from the invention.

FIG. 2B shows a diagram of a backup in accordance with one or more embodiments of the invention. The backup (132A) may be an embodiment of backup A (132A, FIG. 1B) discussed above. As discussed above, backup A may include virtual machine data of an asset of the file system of the production host (110, FIG. 1A). Backup A (132A) may be one or more data structures. The data structures may include one or more virtual machine data blocks (e.g., virtual machine (VM) data block A (210A), VM data block N (210N)) and one or more sector bitmaps (e.g., sector bitmap A (212A), sector bitmap N (212N)). Backup A (132A) may include other and/or additional data structures and/or information without departing from the invention.

In one embodiment of the invention, each virtual machine data block (e.g., 210A, 210N) may refer to a sequence of physically adjacent bytes of data associated with an object that was backed up. A backup may include any number of virtual machine data blocks (e.g., 210A, 210N). Each virtual machine data block (e.g., 210A, 210N) may include any amount of data (e.g., 1MB, 1GB, etc.) without departing from the invention. Each virtual machine data block (e.g., 210A, 210N) associated with a backup may include the same amount of data. The virtual machine data blocks (e.g., 210A, 210N) may be used to restore objects associated with the virtual machines and/or any quantity of portions of the virtual machines on the production host (110, FIG. 1A) that were corrupted and/or lost for any reason without departing from the invention.

In one embodiment of the invention, a sector bitmap (e.g., 212A, 212N) may refer to a bit array that indicates descriptive information regarding the virtual machine data blocks (e.g., 210A, 210N) of a backup (e.g., 132A). Specifically, for a non-differencing disk of the persistent storage (124, FIG. 1A), the sector bitmaps (e.g., 212A, 212N) may distinguish which one or more disk sectors (i.e., portions of the disk) may be occupied with data and, conversely, which one or more other disk sectors may yet to be populated with data. The sector bitmaps (e.g., 212A, 212N) may distinguish which one or more disk sectors of the backup stored in persistent storage (124, FIG. 1A) may represent data that has been changed in reference to a previously generated backup associated with the aforementioned backup. The sector bitmap (e.g., 212A, 212N) may also distinguish which one or more other disk sectors may represent unchanged data respective to the data of the previously generated backup stored in the persistent storage (124, FIG. 1A). The sector bitmap (e.g., 212A, 212N) may refer to other and/or additional types of data structures that indicate descriptive information regarding the virtual machine information regarding the virtual machine data blocks (e.g., 210A, 210N) of a backup (e.g., 132A) without departing from the invention.

FIG. 3A shows a flowchart of a method for generating a full backup in accordance with one or more embodiments of the invention. The method shown in FIG. 3A may be performed by, for example, a backup storage (120, FIG. 1A). Other components of the system illustrated in FIG. 1A may perform all, or a portion, of the method of FIG. 3A without departing from the invention. While various steps in the flowchart are presented and described sequentially, one of ordinary skill in the relevant are will appreciate that some or all of the steps may be executed in different orders, may be combined or omitted, and some or all of the steps may be executed in parallel.

In step 300, a full backup request is obtained. In one or more embodiments of the invention, the production host sends a message to the backup storage. The message may include a request to generate a full backup of an object. The request may specify the object. The request may be obtained from the production host via other and/or additional methods without departing from the invention.

In step 302, virtual machine data blocks are obtained from a production host. In one or more embodiments of the invention, the backup storage sends a message to the production host. The message may include a request for virtual machine data blocks of the object associated with the full backup request. In response to obtaining the request, a backup agent of the production host may generate a snapshot of the virtual machine object. The snapshot may include copies of the virtual machine data blocks associated with the object and send the copies of the virtual machine data blocks to the backup storage. The virtual machine data blocks may be obtained from the production host via other and/or additional methods without departing from the invention.

In step 304, virtual machine data blocks are stored to generate a full backup. In one or more embodiments of the invention, the virtual machine data blocks are stored in persistent storage of the backup storage. The virtual machine data blocks may be written to persistent storage sequentially. The sector bitmaps associated with the virtual machine data blocks may also be updated to indicate that each data block stored in a portion of the persistent storage includes data and is associated with a full backup. The virtual machine data blocks may be stored to generate a full backup via other and/or additional methods without departing from the invention.

In step 306, the backup metadata is updated based on the full backup. In one or more embodiments of the invention, a backup identifier, backup extents, backup type, and a timestamp associated with the full backup are generated. The backup storage may generate a backup identifier associated with the full backup that may be used to differentiate the full backup from other backups stored in persistent storage of the backup storage. The backup identifier may be included in the backup metadata. The backup storage may also generate backup extents associated with the full backup. The backup extents may reference the beginning and end of the virtual machine data blocks of the full backup in persistent storage of the backup storage. The backup extents may be included in the backup metadata. The backup storage may generate a backup type associated with the full backup. The backup storage may indicate that the full backup is a full backup by setting a flag associated with a full backup type and including the flag in the backup metadata. The backup storage may also generate a timestamp by including the date and time the full backup was generated in the backup metadata. The backup storage may also include the object identifier associated with the backed up object included in the full backup with the backup metadata. The object identifier may be associated with the full backup. The backup metadata may be updated based on the full backup via other and/or additional methods without departing from the invention.

The method may end following step 306.

FIG. 3B shows a flowchart of a method for generating a virtual synthetic full backup using an intermediate backup in accordance with one or more embodiments of the invention. The method shown in FIG. 3B may be performed by, for example, a backup storage (120, FIG. 1A). Other components of the system illustrated in FIG. 1A may perform all, or a portion, of the method of FIG. 3B without departing from the invention. While various steps in the flowchart are presented and described sequentially, one of ordinary skill in the relevant are will appreciate that some or all of the steps may be executed in different orders, may be combined or omitted, and some or all of the steps may be executed in parallel.

In step 310, a virtual synthetic full backup request is obtained. In one or more embodiments of the invention, the production host sends a message to the backup storage. The message may include a request to generate a virtual synthetic full backup of an object. The request may specify the object. The virtual synthetic full backup request may be obtained from the production host via other and/or additional methods without departing from the invention.

In step 312, the backup extents of the previous full backup associated with the virtual synthetic full backup request are identified using the backup metadata. In one or more embodiments of the invention, the backup extents of the previous full backup associated with the virtual synthetic full backup request are identified using the object identifiers, backup identifiers, backup types, and timestamps included in the backup metadata. The backup storage may identify all backups stored in persistent storage of the backup storage that are associated with the object using the object identifier associated with the object specified in the virtual synthetic full backup request that is included in the backup metadata. The backup storage may then identify the backups associated with the object that are full backups using the backup types included in the backup metadata. The backup storage may then identify the most recent full backup associated with the object using the timestamps associated with the backups included in the backup metadata. The backup storage may then identify the backup extents of the identified most recent full backup as the backup extents of the previous full backup associated with the virtual synthetic full backup request. In one embodiment of the invention, the previously generated full backup may be a previously generated virtual synthetic full backup without departing from the invention. The backup extents of the previous full backup associated with the virtual synthetic full backup request may be identified using the backup metadata via other and/or additional methods without departing from the invention.

In step 314, an intermediate backup is generated that includes the backup extents of the previous full backup. In one or more embodiments of the invention, the backup storage generates copies of the identified backup extents and includes the backup extent copies in an intermediate backup. The intermediate backup may include only the backup extents of the previous full backup associated with the intermediate backup. In other words, the intermediate backup may include only references to the storage locations of the virtual machine data blocks of the previously generated full backup. The intermediate backup may be generated via other and/or additional methods without departing from the invention.

In step 316, modified virtual machine data blocks are obtained. In one or more embodiments of the invention, the backup storage sends a message to the production host. The message may include a request for virtual machine data blocks of the object associated with the virtual synthetic full backup request that have been modified since the previously generated full backup. The request may include a timestamp associated with the previously generated full backup. In response to obtaining the request, the production host may generate and/or obtain a snapshot of the virtual machine. The snapshot may include copies of the virtual machine data blocks associated with the object that have been modified after the time depicted in the timestamp included in the request and may send the copies of the modified virtual machine data blocks to the backup storage. The modified virtual machine data blocks may be obtained from the production host via other and/or additional methods without departing from the invention.

In step 318, the intermediate backup is updated based on the modified virtual machine data blocks to generate a virtual synthetic full backup. In one or more embodiments of the invention, the modified virtual machine data blocks are included in the intermediate backup. The backup storage may store the modified virtual machine data blocks in persistent storage of the backup storage to generate the virtual synthetic full backup. The backup storage may delete and/or overwrite the backup extents of the previous full backup included in the intermediate backup that are associated with the modified virtual machine data blocks. The sector bitmaps associated with the modified virtual machine data blocks are updated to indicate that each modified data block includes data and is associated with a previously generated full backup. The sector bitmaps may also include entries associated with the backup extents of the previously generated full backup that indicate that the data associated with the backup extents included in the virtual synthetic full backup are stored in another backup (i.e., the previously generated full backup) and were unchanged as of the generation of the virtual synthetic full backup. The intermediate backup may be updated based on the modified virtual machine data blocks to generate a virtual synthetic full backup via other and/or additional methods without departing from the invention.

In step 320, backup metadata is generated based on the virtual synthetic full backup. In one or more embodiments of the invention, a backup identifier, backup extents, backup type, and a timestamp associated with the virtual synthetic full backup are generated. The backup storage may generate a backup identifier associated with the virtual synthetic full backup that may be used to differentiate the virtual synthetic full backup from other backups stored in persistent storage of the backup storage. The backup identifier may be included in the backup metadata. The backup storage may also generate backup extents associated with the virtual synthetic full backup. The backup extents may reference the beginning and end of the modified virtual machine data blocks of the virtual synthetic full backup stored in persistent storage of the backup storage. The backup extents may be included in the backup metadata. The backup storage may generate a backup type associated with the virtual synthetic full backup. The backup storage may indicate that the virtual synthetic full backup is a virtual synthetic full backup by setting a flag associated with a virtual synthetic full backup type and including the flag in the backup metadata. The backup storage may also generate a timestamp by including the date and time the virtual synthetic full backup was generated in the backup metadata. The backup storage may also include the object identifier associated with the backed up object included in the virtual synthetic full backup with the backup metadata. The object identifier may be associated with the virtual synthetic full backup. The backup metadata may be updated based on the virtual synthetic full backup via other and/or additional methods without departing from the invention.

The method may end following step 320.

### EXAMPLE

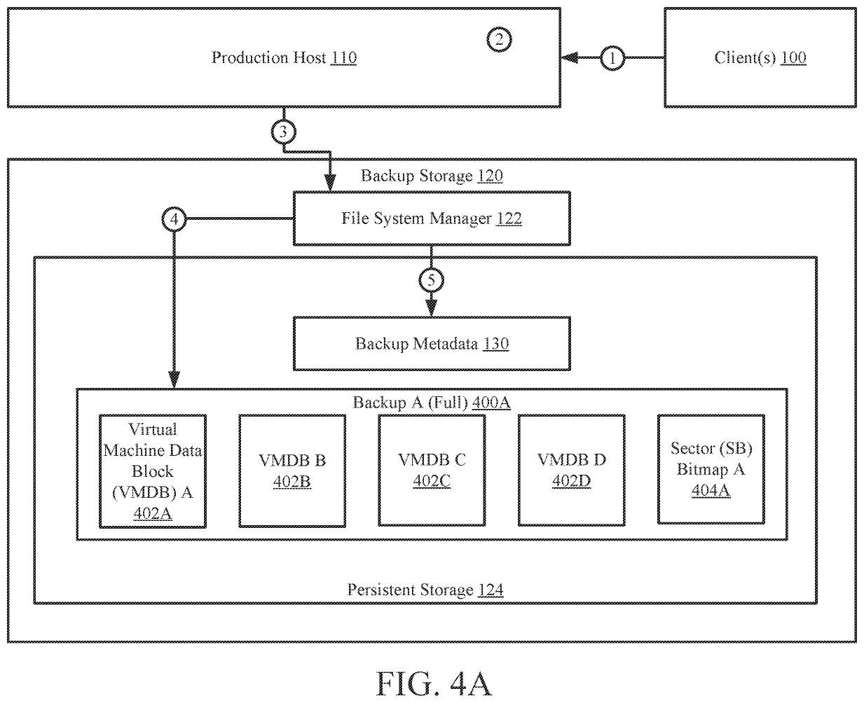

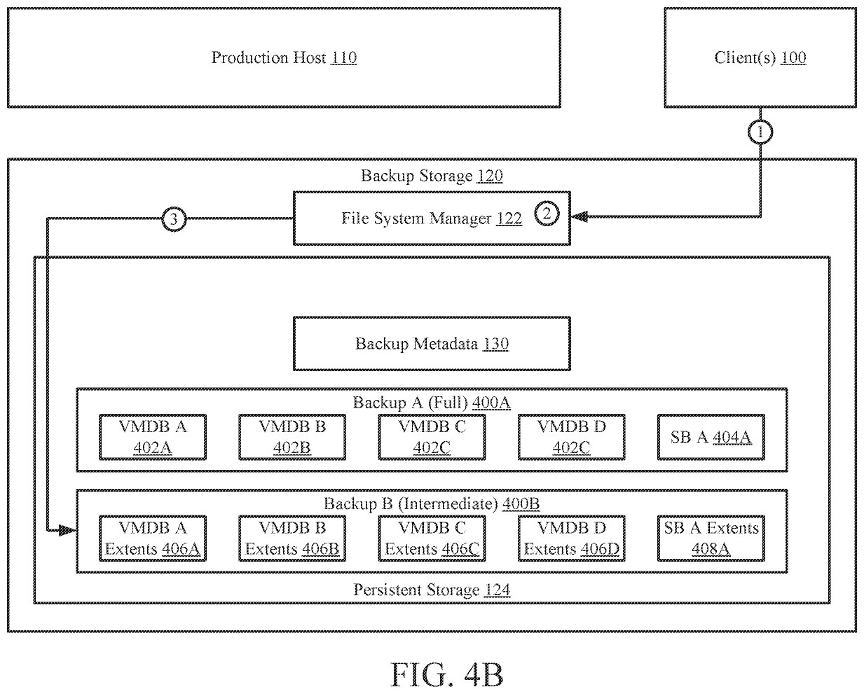

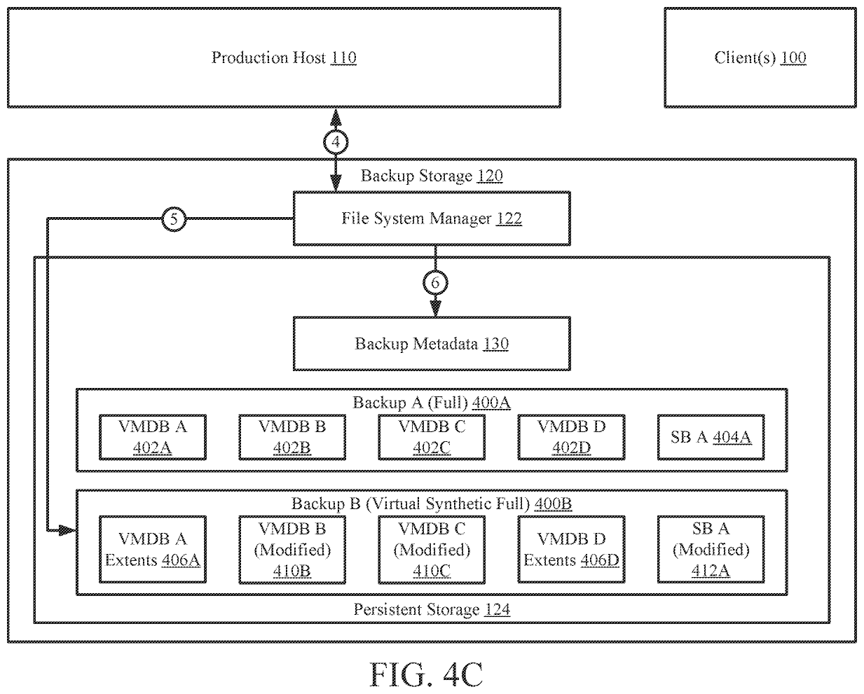

The following section describes two examples. The examples are not intended to limit the invention. The examples are illustrated in FIGS. 4A-4C. Turning to the first example, consider a scenario in which a backup storage stores a full backup of data obtained from a production host.

FIG. 4A shows a diagram of a first example in accordance with one or more embodiments of the invention. As discussed above, a backup storage (120) is generating a full backup of data obtained from a production host (110) as requested by a client(s) (100). The backup storage (120) includes a file system manager (122) and persistent storage (124). At a first point in time, the client(s) (100) sends a request to the production host (110) to generate a backup of a virtual machine hosted by the production host [1]. In response to the request, the production host (110) generates a snapshot of the virtual machine which includes the virtual machine data blocks associated with the virtual machine [2]. The production host (110) then sends the virtual machine data blocks to the file system manager (122) of the backup storage (120) and requests a full backup be generated using the virtual machine data blocks [3]. In response to obtaining the virtual machine data blocks, the file system manager (122) generates backup A (400A) and stores backup A (400A) in persistent storage (124) [4]. Backup A (400A) is a full backup and includes virtual machine data block (VMDB) A (402A), VMDB B (402B), VMDB C (402C), VMDB D (402D), and sector bitmap (SB) A (404A). After storing backup A (400A) in persistent storage (124), the file system manager (122) updates backup metadata (130) based on backup A (400A) [5].

Turning to the second example, consider a scenario in which a backup storage generates a virtual synthetic full backup of the virtual machine discussed above in the first example at a later point in time depicted in FIG. 4A.

FIGS. 4B-4C show a diagram of a second example in accordance with one or more embodiments of the invention. Turning to FIG. 4B, as discussed above, a backup storage (120) is generating a virtual synthetic full backup of the virtual machine obtained from a production host (110) as requested by a client(s) (100). The backup storage (120) includes a file system manager (122) and persistent storage (124). At a first point in time (after the time depicted in FIG. 4A), the client(s) (100) sends a request to the backup storage (120) to generate a virtual synthetic full backup of the virtual machine [1]. In response to the request, the backup storage (120) identifies the backup extents associated with the previously generated full backup (i.e., backup A (400A), which includes VMDB A (402A), VMDB B (402B), VMDB C (402C), VMDB D (402D), and sector bitmap (SB) A (404A)) [2]. The backup storage (120) then generates backup B (400B) [3] using the identified backup extents. Backup B (400B) is an intermediate backup. Backup B (400B) includes VMDB extents A (406A), VMDB extents B (406B), VMDB extents C (406C), VMDB extents D (406D), and SB A extents (408A).

Turning to FIG. 4C, after generating backup B (400B), the file system manager (122) sends a request for modified data blocks associated with the object. The modified data blocks include data blocks of the object that were modified after the generation of backup A (400A) and prior to the generation of backup B (400B). In response to obtaining the request, the production host (110) generates a snapshot of the virtual machine that includes copies of the modified data blocks of the object as specified by the request, and then sends the modified data block copies to the file system manager (122) [4]. In this scenario, VMDB B (402B) and VMDB C (402C) were modified since the generation of backup A (400A). After obtaining the modified data blocks, the file system manager updates backup B (400B) based on the modified data blocks [5]. Backup B (400B) is now a virtual synthetic full backup. Backup B (400B) now includes VMDB A extents (406A), modified VMDB B (410B), modified VMDB C (410C), VMDB D extents (406D), and modified SB A (412A), which was updated based on the modified virtual machine data blocks and the backup extents. After updating backup B (400B) to generate a virtual synthetic full backup, the file system manager (122) updates backup metadata (130) based on the updated backup B (400B) [6].

End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention relate to generating virtual synthetic full backups of virtual machines. An intermediate backup associated with a previously generated full backup may be generated that includes the backup extents of the previously generated full backup. The intermediate backup may be updated to generate a virtual synthetic full backup using virtual machine data blocks that were modified following the generation of the previously generated full backup. Further, the virtual synthetic full backups may include the backup extents that reference the storage locations associated with virtual machine data blocks that were not modified between the generation of the previously generated full backup and the generation of the intermediate backup, and the modified virtual machine data blocks that were modified between the generation of the previously generated full backup and the generation of the intermediate backup.

In traditional systems, the unmodified virtual machine data blocks may be copied from the previously generated full backup and/or obtained from a production host and included in synthetic backups. This may take up unnecessary computational resources of the backup storage and/or the production host to read, write, and/or transmit unmodified virtual machine data blocks to obtain synthetic backups. Embodiments of the invention improve the computational efficiency of generating virtual synthetic full backups by limiting the redundancy in use of computational resources and storage space used to generate virtual synthetic full backups.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for backing up virtual machines, the method comprising:
obtaining, by a backup storage, a virtual synthetic full backup request targeting virtual machine data of a virtual machine; and
in response to the virtual synthetic full backup request:
identifying, in the backup storage, backup extents using backup metadata;
generating an intermediate backup comprising the backup extents, wherein each of the backup extents is a reference to one of a plurality of virtual machine data blocks in a full backup;
obtaining modified virtual machine data blocks from a production host, wherein the modified virtual machine data blocks are obtained from a virtual machine snapshot of the virtual machine data; and
generating a virtual synthetic full backup using the intermediate backup and the modified virtual machine data blocks.

2. The method of claim 1, wherein the virtual synthetic full backup comprises the backup extents and the modified virtual machine data blocks.

3. The method of claim 1, wherein the reference specifies a storage location of the one of the plurality of virtual machine data blocks stored in the backup storage.

4. The method of claim 1, wherein the modified virtual machine data blocks comprise virtual machine data blocks of the full backup that have been modified after generation of the full backup.

5. The method of claim 1, wherein the full backup is one selected from a group consisting of a second virtual synthetic full backup and a non-virtual full backup.

6. The method of claim 1, further comprising:
prior to obtaining the virtual synthetic full backup request:
obtaining a full backup request;
obtaining the plurality of virtual machine data blocks from the production host, wherein the plurality of virtual machine data blocks is associated with a second virtual machine snapshot of the virtual machine data;
storing the plurality of virtual machine data blocks to generate the full backup; and
updating the backup metadata based on the full backup.

7. The method of claim 6, wherein the full backup comprises the plurality of virtual machine data blocks and sector bitmaps.

8. A system for backing up virtual machines, comprising:
persistent storage for storing backup metadata; and
a file system manager of a backup storage, wherein the file system manager is programmed to:
obtain a virtual synthetic full backup request targeting virtual machine data of a virtual machine; and
in response to the virtual synthetic full backup request:
identify, in the backup storage, backup extents using the backup metadata;
generate an intermediate backup comprising the backup extents, wherein each of the backup extents is a reference to one of a plurality of virtual machine data blocks in a full backup;
obtain modified virtual machine data blocks from a production host, wherein the modified virtual machine data blocks from a virtual machine snapshot of the virtual machine data; and
generate a virtual synthetic full backup using the intermediate backup and the modified virtual machine data blocks.

9. The system of claim 8, wherein the virtual synthetic full backup comprises the backup extents and the modified virtual machine data blocks.

10. The system of claim 8, wherein the reference specifies a storage location of the one of the plurality of virtual machine data blocks stored in the backup storage.

11. The system of claim 8, wherein the modified virtual machine data blocks comprise virtual machine data blocks of the full backup that have been modified after generation of the full backup.

12. The system of claim 8, wherein the full backup is one selected from a group consisting of a second virtual synthetic full backup and a non-virtual full backup.

13. The system of claim 8, wherein the file system manager is further programmed to:
prior to obtaining the virtual synthetic full backup request:
obtain a full backup request;
obtain the plurality of virtual machine data blocks from the production host, wherein the plurality of virtual machine data blocks is associated with a second virtual machine snapshot of the virtual machine data;
store the plurality of virtual machine data blocks to generate the full backup; and
update the backup metadata based on the full backup.

14. The system of claim 13, wherein the full backup comprises the plurality of virtual machine data blocks and sector bitmaps.

15. A non-transitory computer readable medium comprising computer readable program code, which when executed by a computer processor enables the computer processor to perform a method for backing up virtual machines, the method comprising:
obtaining, by a backup storage, a virtual synthetic full backup request targeting virtual machine data of a virtual machine; and
in response to the virtual synthetic full backup request:
identifying, in the backup storage, backup extents using backup metadata;
generating an intermediate backup comprising the backup extents, wherein each of the backup extents is a reference to one of a plurality of virtual machine data blocks in a full backup;
obtaining modified virtual machine data blocks from a production host, wherein the modified virtual machine data blocks from a virtual machine snapshot of the virtual machine data; and
generating a virtual synthetic full backup using the intermediate backup and the modified virtual machine data blocks.

16. The non-transitory computer readable medium of claim 15, wherein the virtual synthetic full backup comprises the backup extents and the modified virtual machine data blocks.

17. The non-transitory computer readable medium of claim 15, wherein the reference specifies a storage location of the one of the plurality of virtual machine data blocks stored in the backup storage.

18. The non-transitory computer readable medium of claim 15, wherein the modified virtual machine data blocks comprise virtual machine data blocks of the full backup that have been modified after generation of the full backup.

19. The non-transitory computer readable medium of claim 15, wherein the full backup is one selected from a group consisting of a second virtual synthetic full backup and a non-virtual full backup.

20. The non-transitory computer readable medium of claim 15, wherein the method further comprises:
prior to obtaining the virtual synthetic full backup request:
obtaining a full backup request;
obtaining the plurality of virtual machine data blocks from the production host, wherein the plurality of virtual machine data blocks is associated with a second virtual machine snapshot of the virtual machine data;
storing the plurality of virtual machine data blocks to generate the full backup; and
updating the backup metadata based on the full backup.
